(19) United States
(12) Patent Application Publication
(10) Pub. No.: US 2024/0278794 A1
(43) Pub. Date: Aug. 22, 2024

(54) SYSTEMS AND METHODS FOR CONTROLLING A VEHICLE

(71) Applicant: Toyota Motor Engineering & Manufacturing North America, Inc., Plano, TX (US)

(72) Inventor: Vladimeros Vladimerou, Whitmore Lake, MI (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 18/111,761

(22) Filed: Feb. 20, 2023

(51) Int. Cl. B60W 50/10; B60W 60/00

(52) U.S. Cl. CPC B60W 50/10; B60W 60/001; B60W 2540/18; B60W 2554/4041

(57) ABSTRACT

Systems, methods, and other embodiments described herein relate to controlling a vehicle. In one embodiment, a method includes displaying on a user interface a guideline identifying a potential trajectory for a vehicle. The guideline is based on a steering angle input and a direction input. The method includes updating a shape of the guideline based on user input along a length of the guideline on the user interface to generate an updated guideline and transmitting a control signal to a vehicle control system that causes the vehicle to travel along the updated guideline.

### FIELD

The subject matter described herein relates in general to controlling a vehicle and, more particularly, to controlling an autonomous vehicle.

### BACKGROUND

Modern vehicles include one or more cameras and display devices that can provide rearward driving assistance. Some vehicles further include cameras that provide forward driving assistance. The vehicles may employ visual overlay graphics that are superimposed on a camera image to provide the driving assistance. However, the visual overlay graphics depicting a potential path of travel are limited to displaying a path of travel based on a steering angle.

### SUMMARY

This section generally summarizes the disclosure and is not a comprehensive explanation of its full scope or all its features.

In one embodiment, a method for controlling a vehicle is disclosed. The method includes displaying on a user interface a guideline identifying a potential trajectory for a vehicle. The guideline is based on a steering angle input and a direction input. The method includes updating a shape of the guideline based on user input along a length of the guideline on the user interface to generate an updated guideline. The method further includes transmitting a control signal to a vehicle control system that causes the vehicle to travel along the updated guideline.

In another embodiment, a system for controlling a trailer vehicle is disclosed. The system includes a processor and a memory in communication with the processor. The memory stores machine-readable instructions that, when executed by the processor, cause the processor to display on a user interface a guideline identifying a potential trajectory for a vehicle. The guideline is based on a steering angle input and a direction input. The memory stores machine-readable instructions that, when executed by the processor, cause the processor to update a shape of the guideline based on user input along a length of the guideline on the user interface so as to generate an updated guideline. The memory stores machine-readable instructions that, when executed when executed by the processor, cause the processor to transmit a control signal to a vehicle control system that causes the vehicle to travel along the updated guideline.

In another embodiment, a non-transitory computer-readable medium for controlling a vehicle and including instructions that, when executed by a processor, cause the processor to perform one or more functions, is disclosed. The instructions include instructions to display on a user interface a guideline identifying a potential trajectory for a vehicle. The guideline is based on a steering angle input and a direction input. The instructions include instructions to update a shape of the guideline based on user input along a length of the guideline on the user interface so as to generate an updated guideline. The instructions include instructions to transmit a control signal to a vehicle control system that causes the vehicle to travel along the updated guideline.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates a block diagram of a vehicle incorporating an automated trajectory guidance and execution system.

FIG. 2 is a more detailed block diagram of the automated trajectory guidance and execution system of FIG. 1.

FIG. 3 is an example of a method for controlling a vehicle.

FIGS. 4A-4E are an example of an automated trajectory guidance and execution scenario.

### DETAILED DESCRIPTION

Systems, methods, and other embodiments associated with controlling one or more vehicles are disclosed. More specifically, the systems, methods, and other embodiments are associated with controlling the vehicle as the vehicle travels along a selected trajectory.

A vehicle may include a display located inside the vehicle cabin and in the dashboard. The display may be suitable for displaying a guideline indicating a path of travel for the vehicle based on a steering wheel angle. However, the display is limited to outputting information and the user is unable to control the vehicle by inputting information via the display.

Accordingly, in one embodiment, the disclosed approach is a system that assists a user in controlling the path of travel of a vehicle via a user interface such as a display screen and an input component. The user interface may be located inside the vehicle. Alternatively, the user interface may be located on a mobile device or any other suitable device external to the vehicle. As such, the system may be used to assist a user remotely controlling a vehicle.

The system may be activated by a control signal. The control signal may be based on the user putting the vehicle in a reverse mode, in a drive mode, rotating the steering wheel, or pressing a control button. The system, in response to the control signal, generates a first (also known as an original) guideline using a steering wheel and based on a steering angle. The curvature of the guideline is based on the steering angle. As such, the larger the steering angle, the tighter the curve of the guideline. The system displays the original guideline on the display screen. The display may include a representation of the vehicle and the guideline extending from the front or the rear of the vehicle. The system may display the representation of the vehicle and the guideline(s) in any suitable view. As an example, the system may display the representation of the vehicle and the guideline(s) from a bird's eye view. As another example, the system may display the representation of the vehicle and the guideline(s) from a panoramic view based on the perspective of the vehicle sensors such as the vehicle cameras.

As an example, the system then receives user inputs in the form of the user touching the user interface such as a touchscreen and pushing on the length of the guideline to alter the shape of the original guideline. The user may input an additional guideline (also known as a branching guideline) originating from a point on the original guideline before or after altering the original guideline and extending away from the original guideline. The system may update the curvature and the destination point of the original guideline based on the alterations from the user. Additionally, the system may update the display to include one or more additional guidelines. The system includes activating the vehicle to travelling autonomously along a trajectory that is based on the updated guideline(s).

Current technologies do not disclose being able to control a vehicle using a user interface where the user, using a finger (or any suitable digit), a stylus, or another input component such as a rotatable knob or slide to push on the length of a displayed guideline, is able to alter the curvature of the path of travel of the vehicle.

The embodiments disclose herein present various advantages over current technologies. First, the embodiments can be implemented without the use of complex maps or a Global Positioning System (GPS). The length of the guidelines and the subsequent trajectory that the vehicle travels on are limited to the range (or coverage area) of the sensor system of the vehicle, e.g., 100-yard radius. As such, the system generates the path in segments, e.g., 100-yard segments. Additionally, these embodiments may be implemented with a relatively low number of vehicle sensors. These embodiments also may be implemented with limited computing and data storage resources.

Second, the embodiments assist the user in maintaining precise control of the vehicle making each turn. As such, in a case where the vehicle is off the desired trajectory, the system provides the user with the ability to set the vehicle back on the desired trajectory. These embodiments allow the user to control the vehicle remotely using the touchscreen or any other suitable input component such as a knob, a slide, a switch, a keypad, a button, a joystick, a mouse, a trackball, or a microphone.

As an example, these systems may be beneficial in assisting a user attempting to move a vehicle that is inaccessible (e.g., the vehicle is parked in a tight parking spot). A user outside the vehicle may utilize the system to move the vehicle from a position where the vehicle is inaccessible to an open space where the vehicle door can be opened, and the user can gained access to the vehicle.

Detailed embodiments are disclosed herein; however, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in the figures, but the embodiments are not limited to the illustrated structure or application.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details.

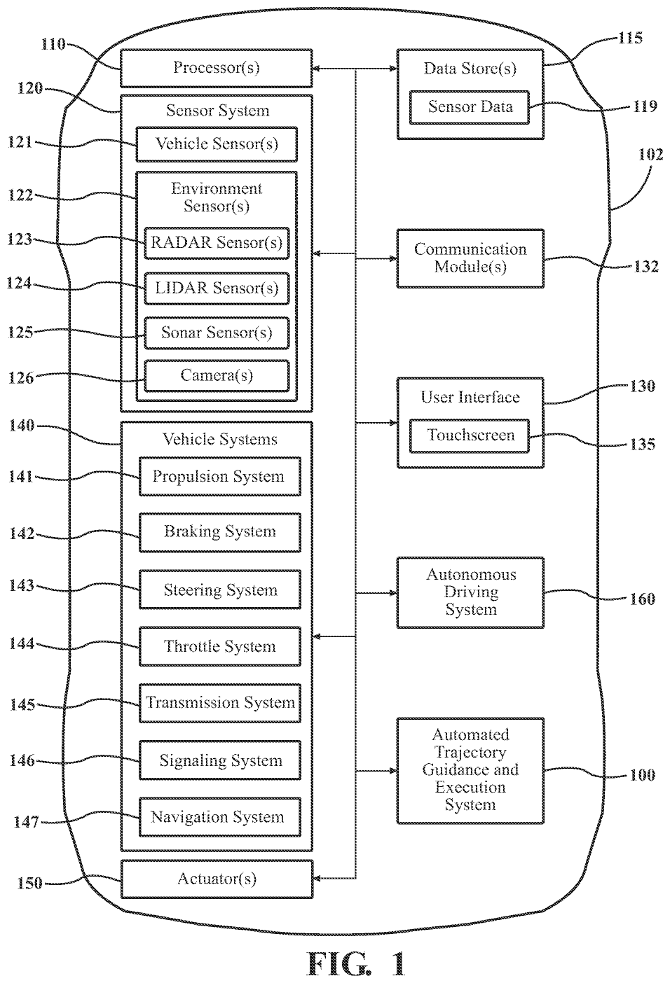

Referring to FIG. 1, a block diagram of a vehicle 102 incorporating an automated trajectory guidance and execution system 100 is illustrated. The vehicle 102 includes a sensor system, a user interface, the automated trajectory guidance and execution system 100, and various elements.

The vehicle 102 can include a user interface 130. The user interface 130 can receive an input from and/or present an output to a user (e.g., a person) or another entity. The user interface 130 includes any device, component, system, element or arrangement, or groups thereof that enable information/data to be entered into a machine. The user interface 130 also includes any device, component, system, element or arrangement, or groups thereof that enable information/data to be presented to the user or other entity. The user interface 130 may be located in a dashboard in the vehicle 102 or in any suitable location in the vehicle 102. Additionally and/or alternatively, the user interface 130 may be located on a mobile device. As an example, the user interface 130 can be a device that the user can view, listen to, touch, press, turn, and/or speak to. In such an example, the user interface 130 may include a touch screen 135, a multi-touch screen, a display, a knob, a slide, a switch, a keypad, a button, a joystick, a mouse, a trackball, a microphone, gesture recognition (radar, lidar, camera, or ultrasound-based), and/or combinations thereof. The user interface 130 may serve as both an input device and an output device, such as a touch screen 135. The touch screen 135 may receive information via a stylus, a finger or thumb of the user, or any other suitable device. As previously mentioned, the user interface 130 may be located in at least one of the vehicle 102 or the mobile device. As such, the user interface 130 may be located on a device that is external to the vehicle 102.

It will be understood that in various embodiments, it may not be necessary for the vehicle 102 to have all of the elements shown in FIG. 1. The vehicle 102 can have any combination of the various elements shown in FIG. 1. Further, the vehicle 102 can have additional elements to those shown in FIG. 1. In some arrangements, the vehicle 102 may be implemented without one or more of the elements shown in FIG. 1. While the various elements are shown as being located within the vehicle 102 in FIG. 1, it will be understood that one or more of these elements can be located external to the vehicle 102. Further, the elements shown may be physically separated by large distances. For example, as discussed, one or more components of the automated trajectory guidance and execution system 100 can be implemented within the vehicle 102 while further components of the automated trajectory guidance and execution system 100 can be implemented within a cloud-computing environment.

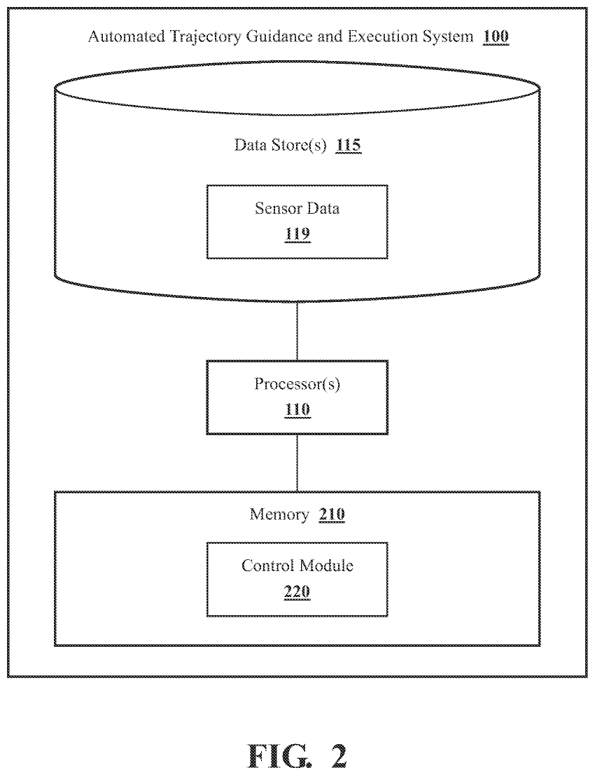

Some of the possible elements of the vehicle 102 are shown in FIG. 1 and will be described along with subsequent figures. However, a description of many of the elements in FIG. 1 will be provided after the discussion of FIGS. 2-4 for purposes of brevity of this description. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements. In any case, as illustrated in the embodiment of FIG. 1, the vehicle 102 includes an automated trajectory guidance and execution system 100 that is implemented to perform methods and other functions as disclosed herein relating to controlling a vehicle. As an example, the automated trajectory guidance and execution system 100, in various embodiments, may be implemented partially within the vehicle 102 and may further exchange communications with additional aspects of the automated trajectory guidance and execution system 100 that are remote from the vehicle 102 in support of the disclosed functions. Thus, while FIG. 2 generally illustrates the automated trajectory guidance and execution system 100 as being self-contained, in various embodiments, the automated trajectory guidance and execution system 100 may be implemented within multiple separate devices some of which may be remote from the vehicle 102.

With reference to FIG. 2, a more detailed block diagram of the automated trajectory guidance and execution system 100 is shown. The automated trajectory guidance and execution system 100 may include a processor(s) 110. Accordingly, the processor(s) 110 may be a part of the automated trajectory guidance and execution system 100, or the automated trajectory guidance and execution system 100 may access the processor(s) 110 through a data bus or another communication pathway. In one or more embodiments, the processor(s) 110 is an application-specific integrated circuit that may be configured to implement functions associated with a control module 220. More generally, in one or more aspects, the processor(s) 110 is an electronic processor, such as a microprocessor that can perform various functions as described herein when loading the control module 220 and executing encoded functions associated therewith.

The automated trajectory guidance and execution system 100 may include a memory 210 that stores the control module 220. The memory 210 may be a random-access memory (RAM), read-only memory (ROM), a hard disk drive, a flash memory, or other suitable memory for storing the control module 220. The control module 220 is, for example, a set of computer-readable instructions that, when executed by the processor(s) 110, cause the processor(s) 110 to perform the various functions disclosed herein. While, in one or more embodiments, the control module 220 is a set of instructions embodied in the memory 210, in further aspects, the control module 220 include hardware, such as processing components (e.g., controllers), circuits, etc. for independently performing one or more of the noted functions.

The automated trajectory guidance and execution system 100 may include a data store(s) 115 for storing one or more types of data. Accordingly, the data store(s) 115 may be a part of the automated trajectory guidance and execution system 100, or the automated trajectory guidance and execution system 100 may access the data store(s) 115 through a data bus or another communication pathway. The data store(s) 115 is, in one embodiment, an electronically based data structure for storing information. In at least one approach, the data store 115 is a database that is stored in the memory 210 or another suitable medium, and that is configured with routines that can be executed by the processor(s) 110 for analyzing stored data, providing stored data, organizing stored data, and so on. In either case, in one embodiment, the data store 115 stores data used by the control module 220 in executing various functions. In one embodiment, the data store 115 may be able to store sensor data 119 and/or other information that is used by the control module 220.

The data store(s) 115 may include volatile and/or non-volatile memory. Examples of suitable data stores 250 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The data store(s) 115 may be a component of the processor(s) 110, or the data store(s) 115 may be operatively connected to the processor(s) 110 for use thereby. The term “operatively connected” or “in communication with” as used throughout this description, can include direct or indirect connections, including connections without direct physical contact.

In one or more arrangements, the data store(s) 115 can include sensor data 119. The sensor data 119 can originate from the sensor system 120 of the vehicle 102. The sensor data 119 can include data from visual sensors, audio sensors, and/or any other suitable sensors in the vehicle 102. The sensor data 119 may include images from in front of the vehicle, from behind the vehicle, and/or from beside the vehicle. As an example, the sensor data 119 may include geographic coordinates of the vehicle 102, and/or any vehicles or objects surrounding the vehicle 102. As another example, the sensor data 119 can include relative positions of the vehicle 102, and/or any vehicles or objects surrounding the vehicle 102.

In one embodiment, the control module 220 may include instructions that, when executed by the processor(s) 110, cause the processor(s) 110 to display on a user interface 130 a guideline identifying a potential trajectory for a vehicle 102. As an example, the control module 220 may display on a touch screen 135 one or more guidelines identifying the potential trajectory for the vehicle 102. The guideline is based on a steering angle input and a direction input. The steering angle input may be a clockwise rotation or a counter-clockwise rotation of the steering wheel. The direction input may be a forward direction as indicated by the vehicle 102 being in a drive mode or a reverse direction as indicated by the vehicle 102 being in a reverse mode.

The control module 220, in one embodiment, may receive data inputs in the form of a steering angle of the vehicle 102. In addition, the control module 220 may receive data inputs in the form of a direction of a potential path of travel. The control module 220 may employ various techniques to acquire the steering angle and/or the direction of the potential path of travel that are either active or passive. For example, the control module 220 may passively sniff the data inputs from a stream of electronic information provided by the various sensors to further components within the vehicle 102. As another example, the control module 220 may actively request and/or poll the steering system 143 and/or the transmission system 145 for data inputs. In such an example, the control module 220 may receive a steering angle from the steering system 143 and/or a direction (e.g., forward or reverse) from the transmission system 145.

The control module 220 generates the guideline(s) including a length, a curvature, and/or a direction based on the steering angle input and the direction input. As an example, in a case where the steering wheel is rotated counter-clockwise, the guideline(s) extending from the position of the vehicle 102 may extend leftwards. As another example, in a case where the steering wheel is rotated clockwise, the guideline(s) extending from the position of the vehicle 102 may extend rightwards. The guideline(s) may extend from the front of the vehicle 102 in a case where the direction is forward, and the guideline(s) may extend from the rear of the vehicle 102 in a case where the direction is reverse. The control module 220 may utilize any suitable method or algorithm to determine and generate the guideline(s). The control module 220 then displays the guideline(s) on the user interface 130, or more specifically, on the touch screen 135. As previously mentioned, the control module 220 displays on the touch screen 135 the guideline identifying the potential trajectory for the vehicle 102. The control module 220 may display a representation of the vehicle 102 and the guideline(s) originating from the front or the rear of the representation of the vehicle 102 to a destination point. The destination point of the guideline is based on a range of a sensor located on the vehicle 102. In other words, the guideline(s) may have two end points—an originating point and a destination point. The originating point of the guideline is located at the vehicle 102. The originating point of the guideline may originate from the front or the rear of the vehicle 102 depending on the direction input. The destination point is the other end of the guideline. The destination point is within the range of the sensors in the sensor system 120. In other words, the destination point may extend as far and not beyond the area that is viewable by any of the sensors on the sensor system 120 of the vehicle 102.

In one embodiment, the control module 220 may include instructions that, when executed by the processor(s) 110, cause the processor(s) 110 to update a shape of the guideline (also known as the original guideline) based on user input along a length of the original guideline on the user interface 130 and/or the touch screen 135 so as to generate an updated guideline. The user input may alter a curvature of the length of the original guideline and/or a destination point of the original guideline to generate the updated guideline. The user input may generate another guideline (also known as a branching guideline). The branching guideline may include an originating point and a destination point. The originating point of the branching guideline may be along the length of either the original guideline or the updated guideline. In other words, the branching guideline may originate from a point along the length of the original guideline or the updated guideline. The destination point of the branching guideline is also within the range of the sensor system 120 of the vehicle 102.

The control module 220 may receive the user input from the user via the stylus or the user's digits. As an example, the control module 220 may alter the curvature of the original guideline in response to the user pushing along the length of the original guideline with the stylus. As another example, the control module 220 may extend the length of the original guideline and/or the position of the destination point in response to the user extending the length of the original guideline using the stylus or a digit.

As an example, the control module 220 may receive the user input from the user via the user interface 130 that includes a knob, a slide, a switch, a keypad, a button, a joystick, a mouse, a trackball, a microphone, gesture recognition (radar, lidar, camera, or ultrasound-based), and/or combinations thereof.

As an example, the control module 220 may generate a branching guideline in response to the user touching a point along the length of the original guideline or the updated guideline and drawing the branching guideline such that the branching guideline originates at the point along the length of the original guideline and extends in the direction of the user's drawing, ending at a destination point. In one example, a portion of the original guideline and the branching guideline become the updated guideline. In such an example, the updated guideline includes the original guideline from the originating point to the point on the original guideline where the branching guideline originates and the length of the branching guideline. Alternatively, the control module 220 alters the original guideline to a first updated guideline and generates the branching guideline originating from a point on the first updated guideline. In such a case, the first updated guideline from the originating point (on the vehicle 102) to the point on the first updated guideline where the branching guideline originates, and the length of the branching guideline form a second updated guideline.

In one embodiment, the control module 220 may include instructions that, when executed by the processor(s) 110, cause the processor(s) 110 to transmit a control signal to a vehicle control system that causes the vehicle 102 to travel along the updated guideline. As such, in response to the vehicle control system receiving the control signal, the vehicle control system may cause the vehicle 102 travel along the updated guideline or the second updated guideline. The vehicle 102 may apply any suitable vehicle control system to identify and travel the updated guideline. As an example, the vehicle 102 may an autonomous vehicle and may include an autonomous driving system 160 that may control the vehicle 102 to travel along the updated guideline or the second updated guideline.

The control module 220 may detect an obstacle along the updated or second updated guideline and may control the vehicle 102 to decelerate or stop traveling along the updated or second updated guideline in response to a vehicle sensor detecting an obstacle along the updated or second updated guideline. The control module 220 may control the vehicle 102 to switch from the vehicle 102 travelling on the original guideline or the first updated guideline to the vehicle 102 travelling on the branching guideline when the control module 220 detects a branch (or a fork) in the guideline.

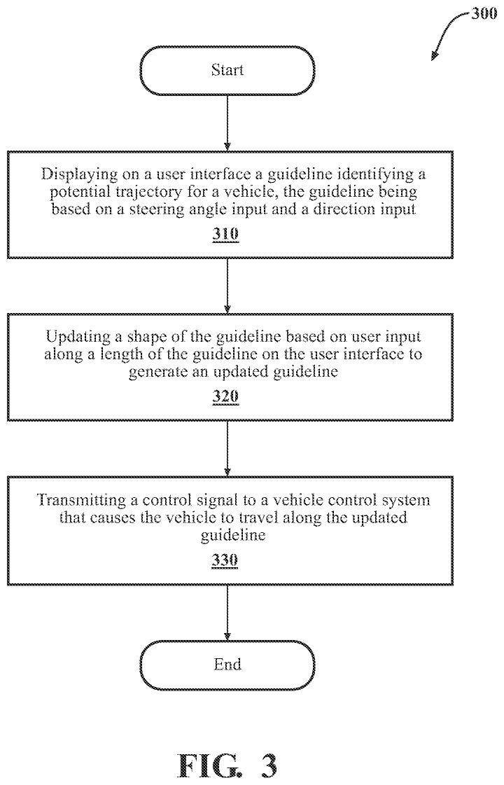

FIG. 3 illustrates a method 300 for controlling a vehicle. The method 300 will be described from the viewpoint of the vehicle 102 of FIG. 1 and the automated trajectory guidance and execution system 100 of FIG. 2. However, the method 300 may be adapted to be executed in any one of several different situations and not necessarily by the vehicle of FIG. 1 and/or the automated trajectory guidance and execution system 100 of FIG. 2.

At step 310, the control module 220 may cause the processor(s) 110 to display on a user interface a guideline (also known as an original guideline) identifying a potential trajectory for a vehicle. The guideline is based on a steering angle input and a direction input. As previously mentioned, and as an example, the control module 220 may generate a guideline based on the steering angle input and the direction input. The control module 220 may then display the guideline on the user interface.

At step 320, the control module 220 may cause the processor(s) 110 to update a shape of the guideline based on user input along a length of the guideline on the user interface to generate an updated guideline. As previously disclosed, the control module 220 may alter the shape of the guideline based on a user touching the guideline, swiping leftwards or rights on the guideline. The control module 220 may generate an updated guideline based on the altered shape of the original guideline.

At step 330, the control module 220 may cause the processor(s) 110 to transmit a control signal to a vehicle control system that causes the vehicle 102 to travel along the updated guideline. As previously mentioned, the control module 220 may activate the vehicle control system such as the autonomous driving system 160 to cause the vehicle 102 to travel along the updated guideline. As an example, the control module 220 may determine a speed of travel for the vehicle 102 and may further select a guideline for the vehicle 102 to follow in the case of multiple guidelines such as multiple branching guidelines.

The method 300 can end. Alternatively, the method 300 can return to step 310 or some other step.

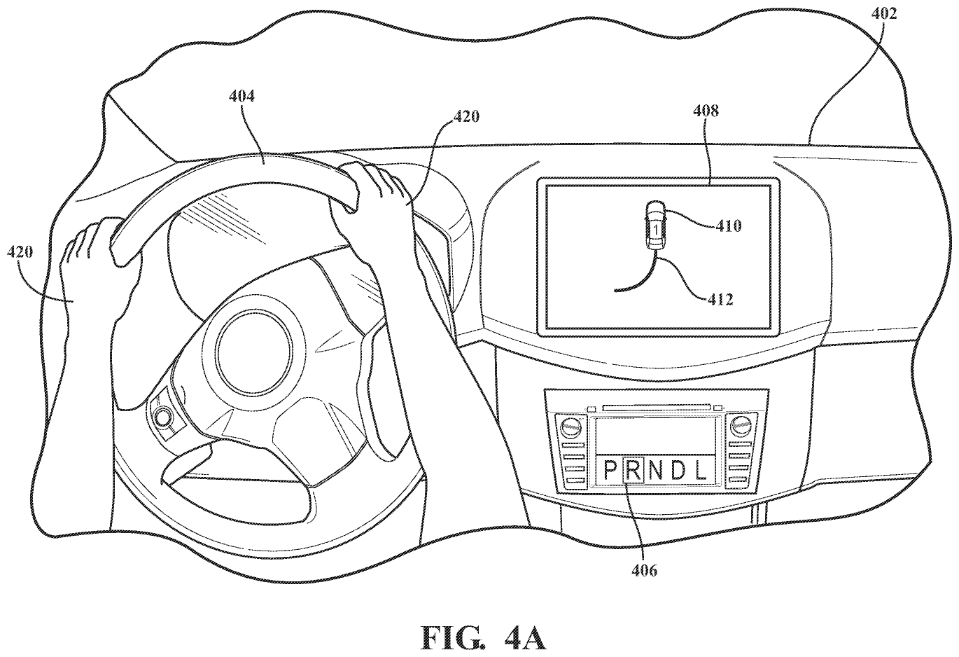

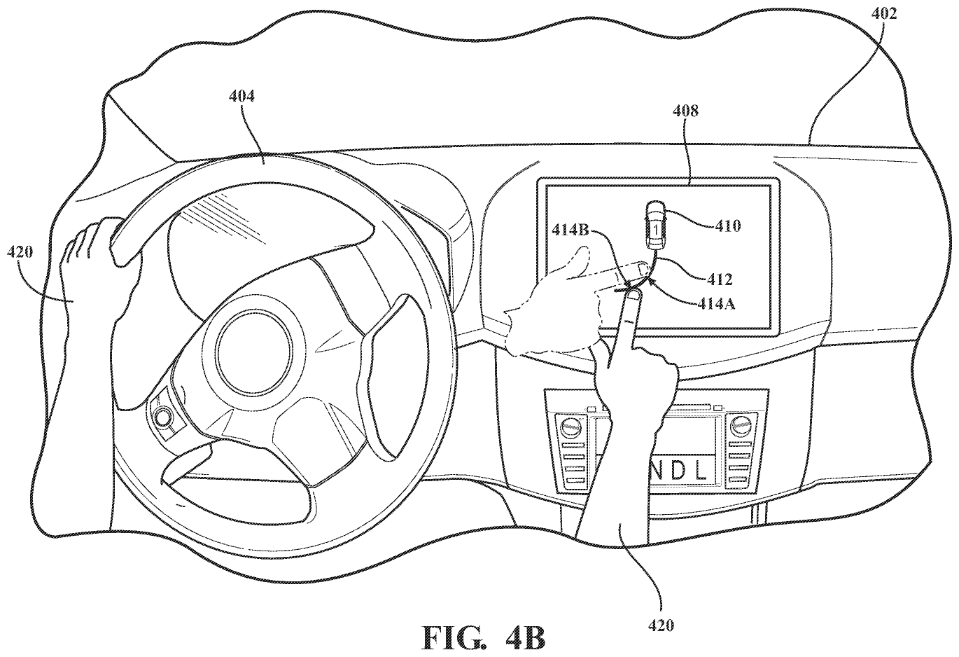

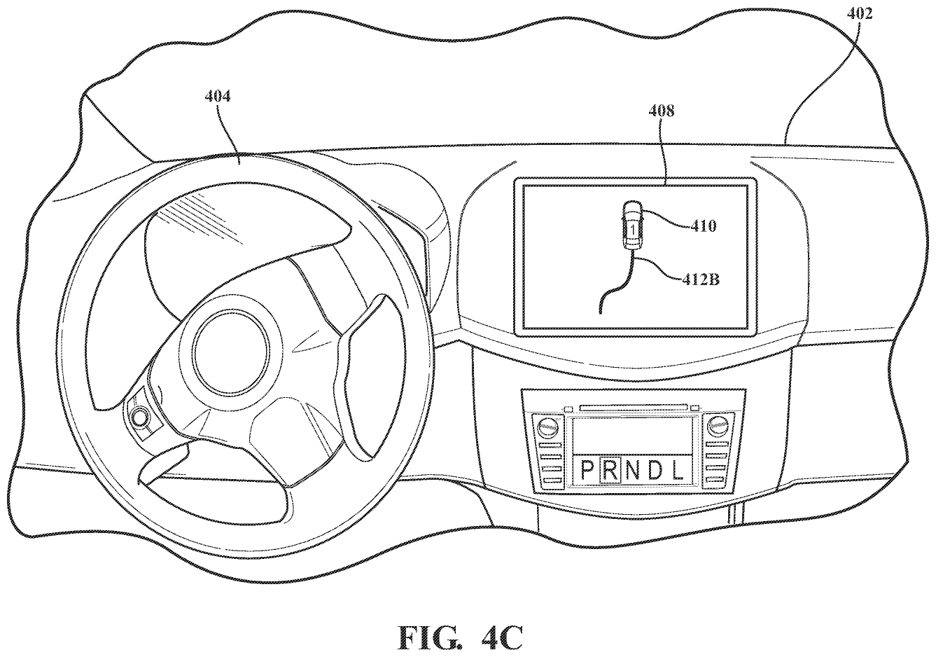

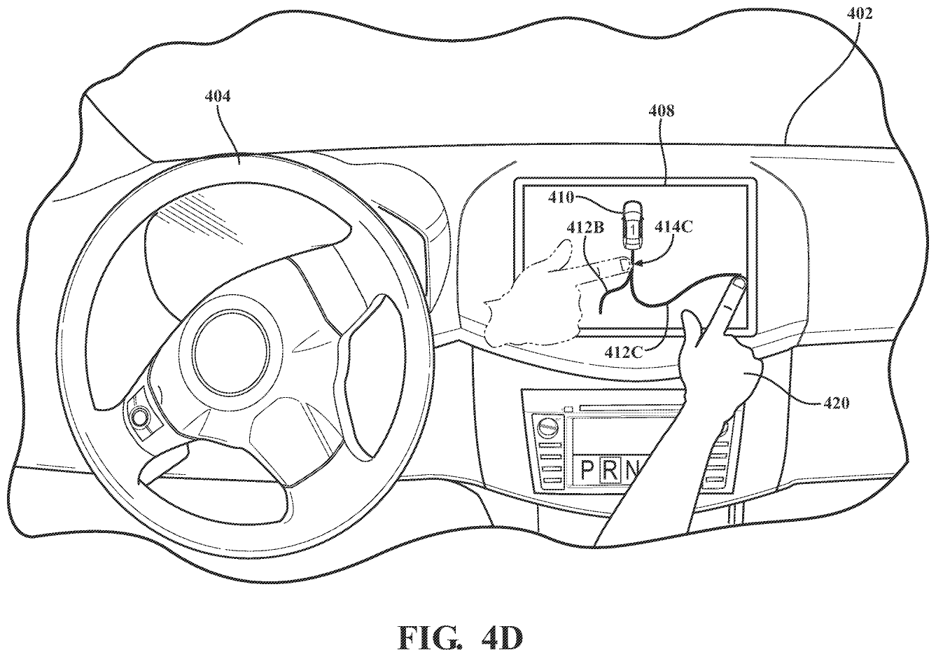

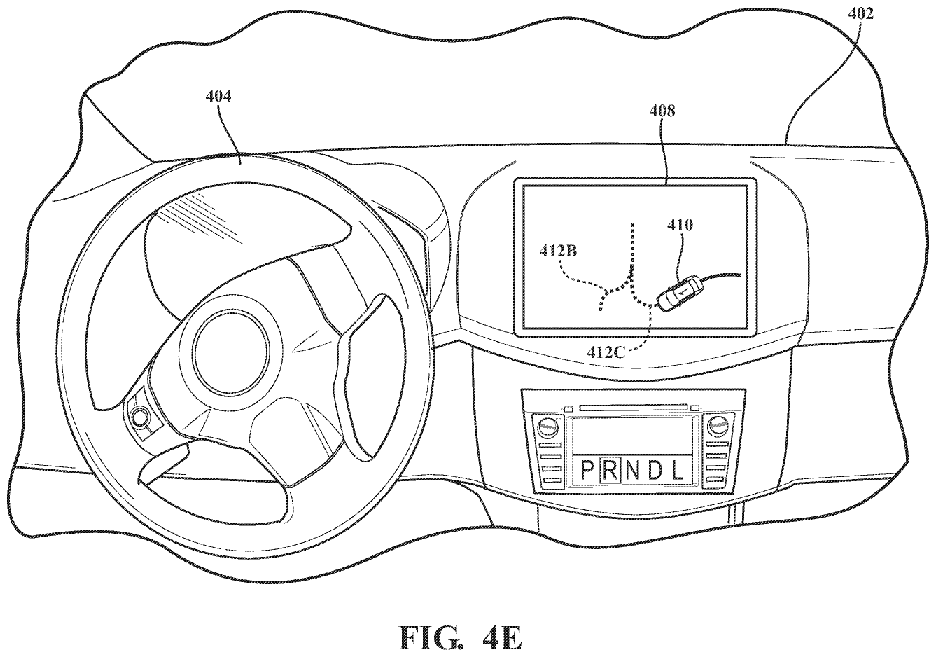

A non-limiting example of the operation of the automated trajectory guidance and execution system 100 and/or one or more of the methods will now be described in relation to FIGS. 4A-4E. FIG. 4A shows an example of a driving scenario with the user 420 rotating a steering wheel 404 in the counter-clockwise direction and the vehicle 402 is in reverse mode 406. The vehicle 402 includes a touchscreen 408. In response to the user putting the vehicle 402 in the reverse mode 406, the control module 220 displays a representation 410 of the vehicle 402 and a guideline 412 on the touchscreen 408.

As shown in FIG. 4B, the user 420 alters the guideline 412 by touching two points 414A, 414B along the length of the guideline 412 on the touchscreen 408. The control module 220 receives the inputted alteration from the user 420.

As shown in FIG. 4C, the control module 220 updates the guideline 412 to the updated guideline 412B based on the alterations received from the user 420. As an example, the user 420 activate the vehicle 402 to travel along the updated guideline 412B and in response, the control module 220 may activate the autonomous vehicle system to cause the vehicle 402 to travel along the updated guideline 412B.

As another example and as shown in FIG. 4D, the user 420 may touch the touchscreen 408 at a point 414C along the length of the updated guideline 412B and draw in another guideline (also known as the branching guideline) 412C.

As shown in FIG. 4E, the control module 220 transmits a control signal to the vehicle control system that causes the vehicle 402 to travel along the updated guideline 412B until the vehicle 402 reaches the point 414C where the updated guideline 412B and the branching guideline 412C meet, and the control module 220 may select for the vehicle 402 to travel along the branching guideline 412C based on input from the user 420.

FIG. 1 will now be discussed in full detail as an example environment within which the system and methods disclosed herein may operate. In some instances, the vehicle 102 is configured to switch selectively between an autonomous mode, one or more semi-autonomous operational modes, and/or a manual mode. Such switching can be implemented in a suitable manner, now known or later developed. “Manual mode” means that all of or a majority of the navigation and/or maneuvering of the vehicle is performed according to inputs received from a user (e.g., human driver). In one or more arrangements, the vehicle 102 can be a conventional vehicle that is configured to operate in only a manual mode.

In one or more embodiments, the vehicle 102 may be an autonomous vehicle. As used herein, “autonomous vehicle” refers to a vehicle that operates in an autonomous mode. “Autonomous mode” refers to navigating and/or maneuvering the vehicle 102 along a travel route using one or more computing systems to control the vehicle 102 with minimal or no input from a human driver. In one or more embodiments, the vehicle 102 is highly automated or completely automated. In one embodiment, the vehicle 102 is configured with one or more semi-autonomous operational modes in which one or more computing systems perform a portion of the navigation and/or maneuvering of the vehicle along a travel route, and a vehicle operator (i.e., driver) provides inputs to the vehicle to perform a portion of the navigation and/or maneuvering of the vehicle 102 along a travel route.

The vehicle 102 can include one or more processors 110. In one or more arrangements, the processor(s) 110 can be a main processor of the vehicle 102. For instance, the processor(s) 110 can be an electronic control unit (ECU). the vehicle 102 can include one or more data stores 115 for storing one or more types of data. The data store 115 can include volatile and/or non-volatile memory. Examples of suitable data stores 115 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The data store 115 can be a component of the processor(s) 110, or the data store 115 can be operatively connected to the processor(s) 110 for use thereby. The term “operatively connected.” as used throughout this description, can include direct or indirect connections, including connections without direct physical contact.

The one or more data stores 115 can include sensor data 119. In this context, “sensor data” means any information about the sensors that the vehicle 102 is equipped with, including the capabilities and other information about such sensors. As will be explained below, the vehicle 102 can include the sensor system 120. The sensor data 119 can relate to one or more sensors of the sensor system 120. As an example, in one or more arrangements, the sensor data 119 can include information on one or more vehicle sensors 121 and/or environment sensors 122 of the sensor system 120.

In some instances, at least a portion of the sensor data 119 can be located in one or more data stores 115 located onboard the vehicle 102. Alternatively, or in addition, at least a portion of the sensor data 119 can be located in one or more data stores 115 that are located remotely from the vehicle 102.

As noted above, the vehicle 102 can include the sensor system 120. The sensor system 120 can include one or more sensors. “Sensor” means any device, component and/or system that can detect, and/or sense something. The one or more sensors can be configured to detect, and/or sense in real-time. As used herein, the term “real-time” means a level of processing responsiveness that a user or system senses as sufficiently immediate for a particular process or determination to be made, or that enables the processor to keep up with some external process.

In arrangements in which the sensor system 120 includes a plurality of sensors, the sensors can work independently from each other. Alternatively, two or more of the sensors can work in combination with each other. In such a case, the two or more sensors can form a sensor network. The sensor system 120 and/or the one or more sensors can be operatively connected to the processor(s) 110, the data store(s) 115, and/or another element of the vehicle 102 (including any of the elements shown in FIG. 1). The sensor system 120 can acquire data of at least a portion of the internal environment as well as the external environment of the vehicle 102 (e.g., nearby vehicles).

The sensor system 120 can include any suitable type of sensor. Various examples of different types of sensors will be described herein. However, it will be understood that the embodiments are not limited to the particular sensors described. The sensor system 120 can include one or more vehicle sensors 121. The vehicle sensor(s) 121 can detect, determine, and/or sense information about the vehicle 102 itself. In one or more arrangements, the vehicle sensor(s) 121 can be configured to detect, and/or sense position and orientation changes of the vehicle 102, such as, for example, based on inertial acceleration. In one or more arrangements, the vehicle sensor(s) 121 can include one or more accelerometers, one or more gyroscopes, an inertial measurement unit (IMU), a dead-reckoning system, a global navigation satellite system (GNSS), a global positioning system (GPS), a navigation system 147, and/or other suitable sensors. The vehicle sensor(s) 121 can be configured to detect, and/or sense one or more characteristics of the vehicle 102. In one or more arrangements, the vehicle sensor(s) 121 can include a speedometer to determine a current speed of the vehicle 102.

Alternatively, or in addition, the sensor system 120 can include one or more environment sensors 122 configured to acquire, and/or sense data around the vehicle. Sensor data around the vehicle can include information about the external environment in which the vehicle is located or one or more portions thereof.

As an example, the one or more environment sensors 122 can be configured to detect, quantify and/or sense vehicles or other objects in at least a portion of the external environment of the vehicle 102 and/or information/data about such vehicles or objects. In the external environment, the one or more environment sensors 122 can be configured to detect, measure, quantify, and/or sense vehicles and objects in the external environment of the vehicle 102, such as, for example, lane markers, signs, traffic lights, traffic signs, lane lines, crosswalks, curbs proximate the vehicle 102, off-road objects, electronic roadside devices, etc.

Various examples of sensors of the sensor system 120 will be described herein. The example sensors may be part of the one or more environment sensors 122 and/or the one or more vehicle sensors 121. However, it will be understood that the embodiments are not limited to the particular sensors described.

As an example, in one or more arrangements, the sensor system 120 can include one or more radar sensors 123, one or more LIDAR sensors 124, one or more sonar sensors 125, and/or one or more cameras 126. In one or more arrangements, the one or more cameras 126 can be high dynamic range (HDR) cameras or infrared (IR) cameras.

The vehicle 102 can include one or more communication modules 132. A “communication module” refers to a component designed to transmit and/or receive information from one source to another. The one or more communication modules 132 transmit and/or receive information via one or more communication networks. The communication network can include an internal vehicle communication network as well as an external communication network.

The internal vehicle communication network can include a bus in the vehicle 102 such as a controller area network (CAN) or the like, and/or other wired and/or wireless mechanisms. The elements of the vehicle 102 such as the data store 115, the sensor system 120, and the processor 110 may be communicatively linked to each other through the internal vehicle communication network. As used herein, the term “communicatively linked” can include direct or indirect connections through a communication channel or pathway or another component or system. Each of the elements of the vehicle 102 can include and/or execute suitable communication software, which enables the various elements to communicate with each other through the communication network and perform the functions disclosed herein.

The external communication network represents one or more mechanisms by which the vehicle 102 may communicate with other vehicles and/or objects, e.g., trailer vehicles, other vehicles, external servers, edge devices and/or roadside units. The external communication network can be implemented as, or include, without limitation, a wide area network (WAN), a local area network (LAN), the Public Switched Telephone Network (PSTN), a wireless network, a mobile network, a Virtual Private Network (VPN), the Internet, one or more intranets, vehicle-to-vehicle (V2V) communication, vehicle-to-cloud (V2C) communication, vehicle-to-infrastructure (V2I) communication, and/or some other form of vehicle-to-everything (V2X) wireless communication. The external communication network further can be implemented as or include one or more wireless networks, whether short-range (e.g., a local wireless network built using a Bluetooth or one of the IEEE 802 wireless communication protocols. e.g., 802.11a/b/g/i, 802.15, 802.16, 802.20, Wi-Fi Protected Access (WPA), or WPA2 or long-range (e.g., a mobile, cellular, and/or satellite-based wireless network; GSM, TDMA, CDMA, WCDMA networks or the like). The communication module(s) 132 can include wired communication links and/or wireless communication links. The communication module(s) 132 can include any combination of the above networks and/or other types of networks.

The vehicle 102 can include one or more vehicle systems 140. Various examples of the one or more vehicle systems 140 are shown in FIG. 1. However, the vehicle 102 can include more, fewer, or different vehicle systems 140. It should be appreciated that although particular vehicle systems are separately defined, each or any of the systems or portions thereof may be otherwise combined or segregated via hardware and/or software within the vehicle 102. the vehicle 102 can include a propulsion system 141, a braking system 142, a steering system 143, throttle system 144, a transmission system 145, a signaling system 146, and/or a navigation system 147. Each of these systems can include one or more devices, components, and/or a combination thereof, now known or later developed.

The navigation system 147 can include one or more devices, applications, and/or combinations thereof, now known or later developed, configured to determine the geographic location of the vehicle 102 and/or to determine a travel route for the vehicle 102. The navigation system 147 can include one or more mapping applications to determine a travel route for the vehicle 102. The navigation system 147 can include a global positioning system, a local positioning system or a geolocation system.

The vehicle 102 can include one or more autonomous driving systems 160. The autonomous driving system 160 can include one or more devices, applications, and/or combinations thereof, now known or later developed, configured to control the movement, speed, maneuvering, heading, direction, etc. of the vehicle 102. The autonomous driving system 160 can include one or more driver assistance systems such as a lane keeping system, a lane centering system, a collision avoidance system, and/or a driver monitoring system.

The autonomous driving system(s) 160 can be configured to receive data from the sensor system 120 and/or any other type of system capable of capturing information relating to the vehicle 102 and/or the external environment of the vehicle 102. In one or more arrangements, the autonomous driving system(s) 160 can use such data to generate one or more driving scene models. The autonomous driving system(s) 160 can determine position and velocity of the vehicle 102. The autonomous driving system(s) 160 can determine the location of obstacles, obstacles, or other environmental features including traffic signs, trees, shrubs, neighboring vehicles, pedestrians, etc.

The vehicle 102 can include one or more actuators 150. The actuators 150 can be any element or combination of elements operable to modify, adjust and/or alter one or more of the vehicle systems 140 or components thereof to responsive to receiving signals or other inputs from the processor(s) 110 and/or the autonomous driving system(s) 160. Any suitable actuator can be used. For instance, the one or more actuators 150 can include motors, pneumatic actuators, hydraulic pistons, relays, solenoids, and/or piezoelectric actuators, just to name a few possibilities.

The vehicle 102 can include one or more modules, at least some of which are described herein. The modules can be implemented as computer-readable program code that, when executed by a processor 110, implement one or more of the various processes described herein. One or more of the modules can be a component of the processor(s) 110, or one or more of the modules can be executed on and/or distributed among other processing systems to which the processor(s) 110 is operatively connected. The modules can include instructions (e.g., program logic) executable by one or more processor(s) 110. Alternatively, or in addition, one or more data store 115 may contain such instructions.

In one or more arrangements, one or more of the modules described herein can include artificial or computational intelligence elements, e.g., neural network, fuzzy logic or other machine learning algorithms. Further, in one or more arrangements, one or more of the modules can be distributed among a plurality of the modules described herein. In one or more arrangements, two or more of the modules described herein can be combined into a single module.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-4, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Generally, modules, as used herein, include routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . .” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A method comprising:
displaying on a user interface a guideline identifying a potential trajectory for a vehicle, the guideline being based on a steering angle input and a direction input;
updating a shape of the guideline based on user input along a length of the guideline on the user interface to generate an updated guideline; and
transmitting a control signal to a vehicle control system that causes the vehicle to travel along the updated guideline.

2. The method of claim 1, wherein a destination point of the guideline is based on a range of a sensor located on the vehicle.

3. The method of claim 1, wherein the direction input is one of:
forward direction; or
reverse direction.

4. The method of claim 1, wherein the user interface is located in at least one of:
the vehicle; or
a mobile device.

5. The method of claim 1, wherein the user input alters at least one of:
a curvature of the length of the guideline; or
a destination point of the guideline.

6. The method of claim 1, further comprises:
transmitting a second control signal to the vehicle control system that causes the vehicle to decelerate in response to detecting an obstacle along the updated guideline.

7. The method of claim 1, wherein the user input generates an other guideline, the other guideline includes an originating point and the originating point is along the length of the guideline.

8. A system comprising:
a processor; and
a memory storing machine-readable instructions that, when executed by the processor, cause the processor to:
display on a user interface a guideline identifying a potential trajectory for a vehicle, the guideline being based on a steering angle input and a direction input;
update a shape of the guideline based on user input along a length of the guideline on the user interface to generate an updated guideline; and
transmit a control signal to a vehicle control system that causes the vehicle to travel along the updated guideline.

9. The system of claim 8, wherein a destination point of the guideline is based on a range of a sensor located on the vehicle.

10. The system of claim 8, wherein the direction input is one of:
forward direction; or
reverse direction.

11. The system of claim 8, wherein the user interface is located in at least one of:
the vehicle; or
a mobile device.

12. The system of claim 8, wherein the user input alters at least one of:
a curvature of the length of the guideline; or
a destination point of the guideline.

13. The system of claim 8, wherein the memory further stores machine-readable instructions that, when executed by the processor, cause the processor to:
transmit a second control signal to the vehicle control system that causes the vehicle to decelerate in response to detecting an obstacle along the updated guideline.

14. The system of claim 8, wherein the user input generates an other guideline, the other guideline includes an originating point and the originating point is along the length of the guideline.

15. A non-transitory computer-readable medium including machine-readable instructions that, when executed by a processor, cause the processor to:
display on a user interface a guideline identifying a potential trajectory for a vehicle, the guideline being based on a steering angle input and a direction input;
update a shape of the guideline based on user input along a length of the guideline on the user interface to generate an updated guideline; and
transmit a control signal to a vehicle control system that causes the vehicle to travel along the updated guideline.

16. The non-transitory computer-readable medium of claim 15, wherein a destination point of the guideline is based on a range of a sensor located on the vehicle.

17. The non-transitory computer-readable medium of claim 15, wherein the direction input is one of:
forward direction; or
reverse direction.

18. The non-transitory computer-readable medium of claim 15, wherein the user interface is located in at least one of:
the vehicle; or
a mobile device.

19. The non-transitory computer-readable medium of claim 15, wherein the user input alters at least one of:
a curvature of the length of the guideline; or
a destination point of the guideline.

20. The non-transitory computer-readable medium of claim 15, further comprising machine-readable instructions that, when executed by the processor, cause the processor to:
transmit a second control signal to the vehicle control system that causes the vehicle to decelerate in response to detecting an obstacle along the updated guideline.
